(19) United States
(12) Patent Application Publication
(10) Pub. No.: US 2024/0413307 A1
(43) Pub. Date: Dec. 12, 2024

(54) Increasing Electrical Power Output Of An Energy Source

(71) Applicant: Microsoft Technology Licensing, LLC, Redmond, WA (US)

(72) Inventors: Vaidehi ORUGANTI, Kirkland, WA (US); Husam Atallah ALISSA, Snoqualmie, WA (US); Christian L. BELADY, Mercer Island, WA (US)

(21) Appl. No.: 18/208,133

(22) Filed: Jun. 9, 2023

(51) Int. Cl. H01M 4/36

(52) U.S. Cl. CPC H01M 4/366; H01M 2004/021

(57) ABSTRACT

Techniques for increasing an atomic surface area of contact surfaces of an energy source to cause the energy source to increase its energy output are disclosed. An energy source includes first and second contact surfaces, where these contact surfaces are structured to facilitate energy transfer between the energy source and a receiving unit. The contact surfaces each have a first surface area state with a first amount of atomic surface area. A process is applied to the contact surfaces to change the first surface area state to a second surface area state. The second surface area state has a second amount of atomic surface area which is more than the first amount of atomic surface area. The applied process may include applying a current or applying a short to the contact surfaces.

### BACKGROUND

With the development of high-performance computers, electric cars, and other devices that rely on electrical power from energy sources, batteries have become a significant area of research and development. These electrical devices rely on electrical power from batteries and other energy sources to operate properly and efficiently.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a method for increasing an atomic surface area of contact surfaces of an energy source to thereby cause the energy source to increase an amount of energy output the energy source is capable of providing relative to an amount of energy output the energy source was capable of providing prior to the atomic surface area being increased, said method including: providing an energy source, wherein the energy source includes a first contact surface and a second contact surface, the first and second contact surfaces being structured to facilitate a transfer of energy from the energy source to a receiving unit, and wherein the first and second contact surfaces initially have a first surface area state in which the first and second contact surfaces have a first amount of atomic surface area; and applying a process to change the first surface area state to a second surface area state in which the first and second contact surfaces have a second amount of atomic surface area, which is an increased amount of atomic surface area relative to the first amount of atomic surface area.

In some aspects, the techniques described herein relate to an energy source that is structured to increase an atomic surface area of contact surfaces of the energy source to thereby cause the energy source to increase an amount of energy output the energy source is capable of providing relative to an amount of energy output the energy source was capable of providing prior to the atomic surface area being increased, the energy source including: a first contact surface; and a second contact surface; wherein: the first and second contact surfaces are structured to facilitate a transfer of energy from the energy source to a receiving unit, the first and second contact surfaces initially have a first surface area state in which the first and second contact surfaces have a first amount of atomic surface area, and a current is applied to the first and second contact surfaces to change the first surface area state to the second surface area state in which the first and second contact surfaces have a second amount of atomic surface area, which is an increased amount of atomic surface area relative to the first amount of atomic surface area.

In some aspects, the techniques described herein relate to an energy source that is structured to increase an atomic surface area of contact surfaces of the energy source to thereby cause the energy source to increase an amount of energy output the energy source is capable of providing relative to an amount of energy output the energy source was capable of providing prior to the atomic surface area being increased, the energy source including: a first contact surface; and a second contact surface; wherein: the first and second contact surfaces are structured to facilitate a transfer of energy from the energy source to a receiving unit, the first and second contact surfaces initially have a first surface area state in which the first and second contact surfaces have a first amount of atomic surface area, and a short is applied to the first and second contact surfaces to change the first surface area state to the second surface area state in which the first and second contact surfaces have a second amount of atomic surface area, which is an increased amount of atomic surface area relative to the first amount of atomic surface area.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIGS. 1A and 1B illustrate examples of energy sources.

FIG. 2 illustrates an example of a current being applied to an energy source to modify the atomic surface area of the energy source in order to increase that energy source's power output.

FIG. 3 illustrates an example of a short being applied to an energy source to also increase that energy source's power output by increasing the atomic surface area of the energy source.

FIG. 4 illustrates a scanning electron microscopy (SEM) image of a contact surface with an increased atomic surface area.

FIG. 5 illustrates experimental results of an increased power output of an energy source.

FIGS. 6 through 8 illustrate various different flowcharts of example methods for increasing a power output of an energy source.

### DETAILED DESCRIPTION

There are numerous different types of energy sources. Examples of such energy sources include batteries, capacitors, and inductors. There are many different types of batteries. Examples of these battery types include, but certainly are not limited to, lithium batteries, silver oxide batteries, alkaline batteries, die-integrated flow batteries, lead-acid batteries, and many other types.

Connections are typically included as a part of the battery. These connections enable the stored energy in the battery to be delivered to an external or receiving unit. These connections are often called “terminals” or “electrodes.”

Regarding a battery's terminals, a battery typically has a positive terminal and a negative terminal. Electrons flow toward the positive terminal when the battery is used in a closed circuit. Electrons flow from the negative terminal when the battery is used in the closed circuit.

As used herein, the terms “terminal” and “electrode” can be used interchangeably. Generally, a terminal/electrode refers to the connection element of a battery source, where that connection element enables the energy source to be electrically coupled to an external unit, such as perhaps the terminals of a different device, wires, or other electrical components.

Over the years, there have been many attempts to try to increase the power output of an energy source, and particularly a battery. One can appreciate how, if an energy source can provide increased power output, then the energy source can be used in a wider range of operations. As such, it is generally desirable to develop techniques to improve the power output of energy sources.

The disclosed embodiments bring about numerous benefits, advantages, and practical applications to the technical field of energy source development, and in particular to increasing the power output of energy sources. As will be described herein, rapid techniques to improve and scale the power output from a battery are achieved by enhancing the battery's chemical to electrical conversion using strategies of increased electrode surface area. That is, the disclosed embodiments beneficially increase the amount of surface area (at an atomic level) of an energy source's electrodes. By increasing the atomic surface area of an energy source's electrodes, an increased amount of power can be delivered by the power source. In other words, the disclosed embodiments significantly improve how an energy source operates and how it delivers power.

By configuring an energy source in the disclosed manner, various other significant advantages can be achieved. For instance, improvements in how power is delivered to data centers, electronic devices, and electric vehicles (EV) can be realized. This disclosure focuses on various different example types of energy sources, such as a flow battery integrated inside a complementary metal-oxide semiconductor (CMOS) die. It should be noted, however, how the disclosed concepts can be extended to any energy source type, including, but certainly not limited to, macroscopic redox flow batteries, solid-state batteries (e.g., lithium-ion batteries), lead acid batteries, and so on.

Generally, the disclosed embodiments relate to systems and methods that increase power output of an energy source by modifying a first and second contact surface (e.g., the electrodes or terminals) of that energy source. To do so, the disclosed embodiments change the surface area characteristics (e.g., at an atomic level) of the first and second contact surfaces. This change occurs by applying a process that includes either applying a current or applying a short to those contact surfaces. Applying this process operates to increase the amount of surface area (at an atomic level) of those contact surfaces. Having an increased amount of surface area allows increased energy (e.g., electrons) to flow through those contact surfaces. Stated differently, the disclosed systems and methods change an electrode's surface area at an atomic level by increasing an atomic surface area of that electrode, resulting in an increased energy output capacity of the energy source relative to the energy output capacity of the energy source as it was originally manufactured.

More specifically, the embodiments are directed to various mechanisms for improving the electrical power delivery from an energy source (e.g., a flow battery) by several fold using a process of electrode shorting or passing high current through the electrodes to enhance that energy source's surface characteristics. This technology has a capacity to increase the power delivery by at least 20× without changing the design of the battery. When the electrodes of an energy source (e.g., a micro flow battery) are shorted or when high currents (e.g., currents that exceed a threshold level) are passed through the electrodes, atomic scale erosion of the electrode surface occurs, resulting in an increase in surface area of the electrode by several fold. This increase in surface area of the electrode results in improvements in electrical power output of the energy source (e.g., a micron sized flow battery) and can be performed without changing the design or materials of the battery.

Additionally, the embodiments may be modified to optimize a maximum energy output for the energy source when a particular voltage is applied to the energy source or is required of the energy source. The embodiments are particularly advantageous since some devices utilizing an energy source operate at a single or a few particular voltages. Accordingly, these and numerous other benefits will now be described in more detail throughout the remaining portions of this disclosure.

### Energy Source Architecture

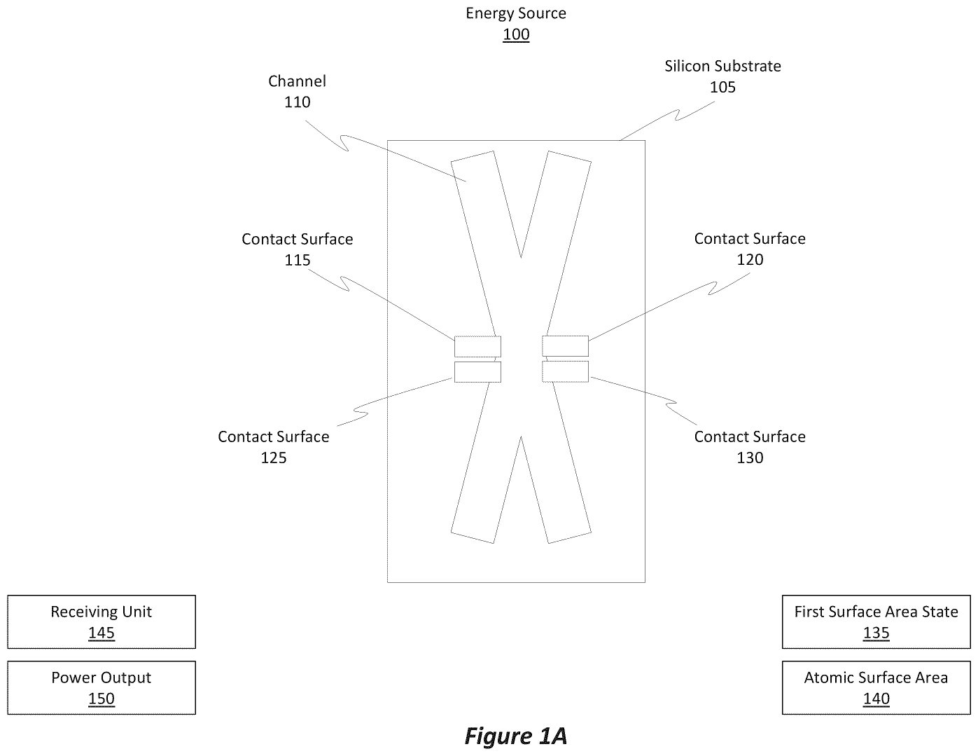

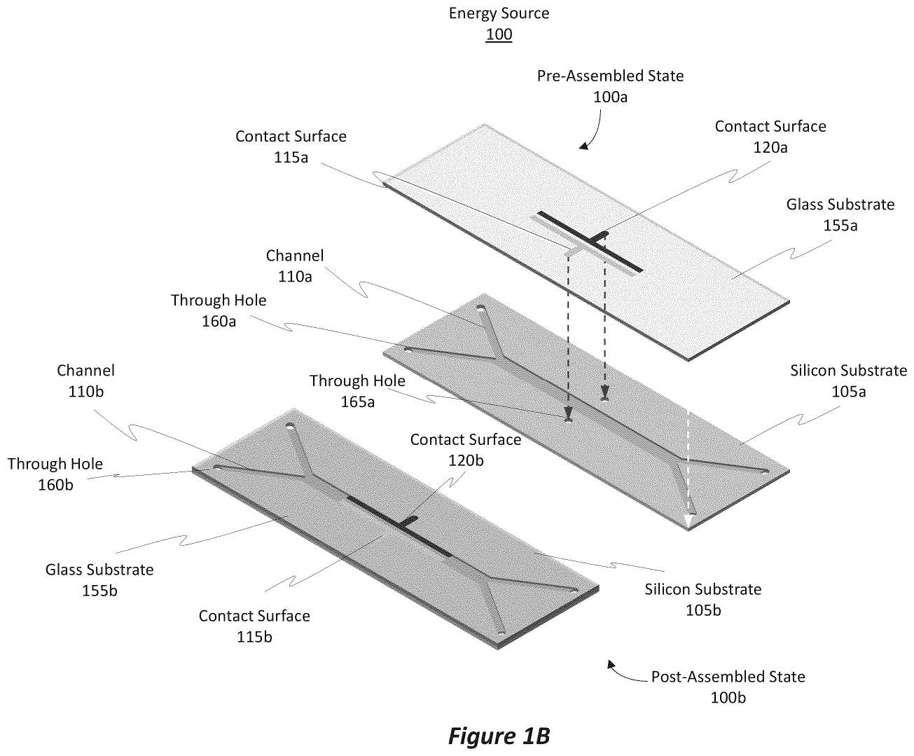

FIG. 1A shows an example of an energy source 100. Energy source 100 includes a silicon substrate 105, also referred to as a silicon wafer, with a channel 110 etched into the silicon substrate 105. Channel 110 is etched into silicon substrate 105 by a process that involves at least one of: masking, photo-resisting, and/or dry chemical reactive ion etching processes. In some embodiments, multiple channels 110 are etched into the silicon substrate 105.

FIG. 1A also shows contact surface 115, contact surface 120, contact surface 125, and contact surface 130. While four contact surfaces are shown in FIG. 1A, in some cases, the energy source 100 includes two contact surfaces, three contact surfaces, four contact surfaces, or more than four contact surfaces. The contact surfaces 115, 120, 125, and 130 initially have a first surface area state 135. The first surface area state 135 is defined as each contact surface 115, 120, 125, and 130 having an atomic surface area 140. As an example, the first surface area 140 can be thought of being smooth.

FIG. 1A also shows a receiving unit 145 and a power output 150. The receiving unit 145 is connected to the contact surfaces 115 120, 125, and 130. When the energy source 100 produces a power output 150, the contact surfaces 115, 120, 125, and 130 facilitate the transfer of energy from the power output 150 to the receiving unit 145.

In some embodiments, energy source 100 is a battery. Examples of batteries may include lithium-ion batteries, silver-platinum batteries, carbon-zinc batteries, alkaline batteries, flow batteries, solid-state batteries, silver-oxide batteries, zinc-air batteries, nickel-cadmium batteries, or other appropriate batteries. In some embodiments, the contact surfaces 115, 120, 125, and 130 are electrodes, heat exchangers, or other appropriate contact surfaces. In some embodiments, the receiving unit 145 may be a device, a component within a device, another contact surface, or other element/device/component that receives power from an energy source.

FIG. 1B shows another example of an energy source 100. FIG. 1B shows the energy source 100 in a pre-assembled state 100a and post-assembled state 100b. In the pre-assembled state 100a, the energy source 100 includes a silicon substrate 105a with an etched channel 110a. The energy source 100 also includes four through holes 160a at the ends of the channel 110a and two through holes 165a at the center of the silicon substrate 105a.

FIG. 1B also shows a glass substrate 155a in the pre-assembled state 100a of energy source 100. The glass substrate 155a includes contact surface 115a and contact surface 120a. The glass substrate 155a is coupled with the silicon substrate 105a using the through holes 160a and 165a shown by arrows in the pre-assembled state 100a.

In the post-assembled state 100b, FIG. 1B shows the energy source 100 with the glass substrate 155b on top of the silicon substrate 105b. The channel 110b that is etched on the silicon substrate 105b is beneath the glass substrate 155b. The glass substrate 155b includes the contact surface 115b and the contact surface 120b. Additionally, the glass substrate 155b is coupled with the silicon substrate 105b via the through holes 160b at the ends of the channel 110b and the through holes 160a in the middle of the silicon substrate 105b, which are not pictured due to being covered by the contact surface 115b and contact surface 120b.

### Applied Processes to Change Atomic Surface Area

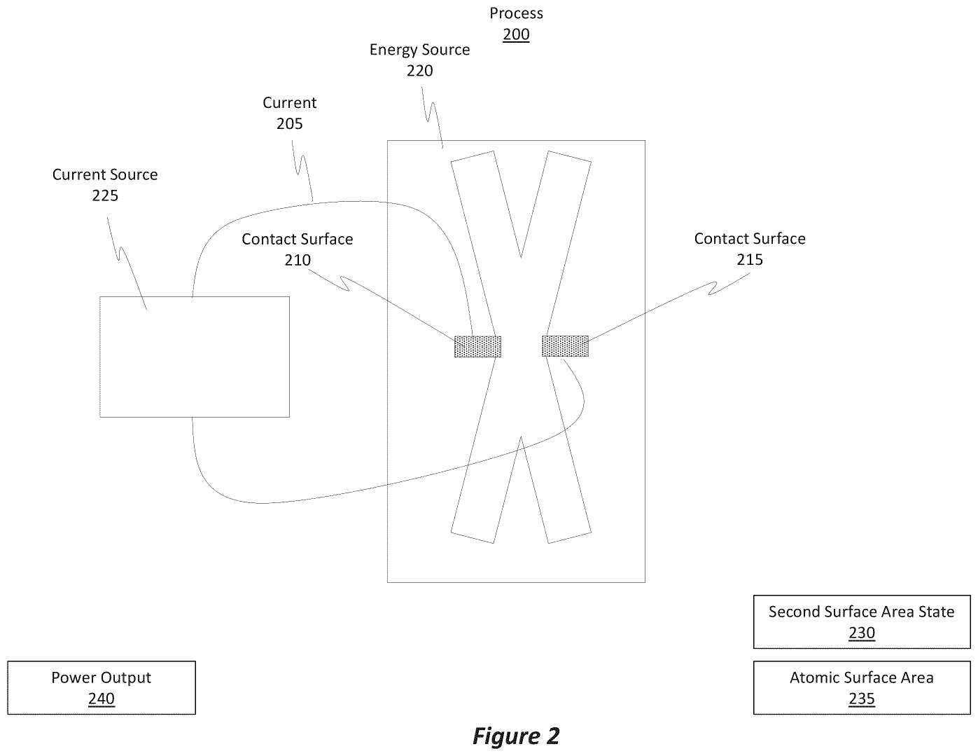

FIG. 2 shows an example process 200 in which a current 205 is being applied to the contact surface 210 and contact surface 215 of the energy source 220. The current 205 is applied to the energy source 220 by a current source 225. Applying the current 205 to the contact surface 210 and the contact surface 215 results in the surface areas of the contact surfaces 210 and 215 changing from a first surface area state 135 to a second surface area state 230.

Stated differently, the amount of surface area of those contact surfaces 210 and 215 increases as a result of applying the current 205. By having an increased amount of surface area, an increased amount of electrons can flow from the energy source 220 to a receiving unit. In the second surface area state 230, the contact surfaces 210 and 215 now have an increased atomic surface area 235. That is, the atomic surface area 235 associated with the second surface area state 230 has an increased amount of atomic surface area relative to the first atomic surface area 140 from FIG. 1A.

In some cases, the current 205 applied by the current source 225 to the contact surfaces 210 and 215 is within a range spanning anywhere from about 50 milliamps (mA) to about 600 mA. In some cases, the current is less than about 50 mA. In some cases, the current is about 100 mA, about 150 mA, about 200 mA, about 300 mA, about 400 mA, about 500 mA, about 550 mA, or about 600 mA. In some cases, higher currents can be used, such as currents that exceed about 600 mA.

In some instances, the current 205 is applied by the current source 225 to the contact surfaces 210 and 215 only once. In other instances, the current 205 is applied by the current source 225 to the contact surface 210 and 215 more than once (e.g., 2, 3, 4, or more than 4 times).

In one instance, the increased amount of atomic surface area 235 in the second surface area state 230 relative to the first surface area state 135 is due to ions being deposited onto the contact surfaces 115 and 120, thereby changing the contact surface 210 and 215 to have the second surface area state 230. With the second surface area state 230, the atomic surface area 235 includes atomic voids, dents, concave portions, convex portions, protrusions, bubbling effects, or other increased roughness due to the presence of atomic ions, relative to the first atomic surface area 140.

As a result of the increased atomic surface area 235 on the contact surfaces 210 and 215, the power output 240 capacity of the energy source 220 increases relative to the initial power output 150 capacity of the energy source 100 (i.e. before the surface area change occurred). This change occurs because, with the increased atomic surface area, more electrons can now flow through the electrodes.

The change in power output capacity is significant as a result of performing the disclosed operations. For example, the power output capacity difference as between the first power output 150 capacity of the energy source 100 and the second power output 240 of the energy source 220 may be any value greater than 1×. In some cases, the difference is about 5×, about 10×, about 15×, about 16×, about 20×, about 25×, or more than about 25×. From this, a skilled person can observe how significant improvements to the power output of the energy source can be realized as a result of practicing the disclosed principles.

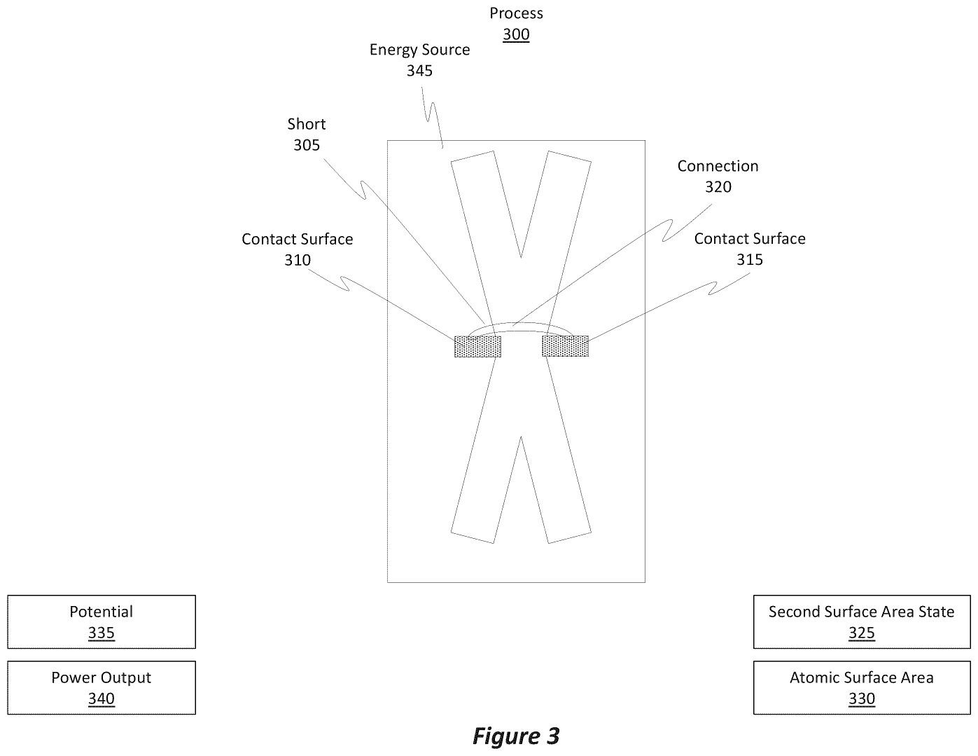

FIG. 3 illustrates another example process 300 for increasing an energy source's power output. Whereas FIG. 2 was focused on a scenario in which a current was applied to the electrodes of the energy source, FIG. 3 is now focused on a scenario in which a shorting effect is applied to the electrodes. In particular, FIG. 3 shows a process 300 of applying a short 305 to the contact surface 310 and contact surface 315. The short 305 is applied to the contact surface 310 and contact surface 315 by a connection 320. Stated differently, the contact surfaces 310 and 315 are shorted together, thereby eliminating a voltage potential that previously existed between those contact surfaces 310 and 315.

In some instances, the connection 320 is formed of a copper wire or other appropriate connection material. The short 305 between the contact surfaces 310 and 315 results in the first surface area state 135 changing to a second surface area state 325. The second surface area state 325 has a second atomic surface area 330, which has an increased amount of atomic surface area relative to the first atomic surface area 140.

When the short 305 is applied to the contact surface 310 and the contact surface 315, which are connected by the connection 320, the potential 335 difference between the first and second contact surfaces is removed. In other words, prior to the short 305 being applied to contact surface 310 and contact surface 315, the contact surfaces 310 and 315 have a potential energy difference that is non-zero. Once the short 305 is applied to the contact surfaces 310 and 315 via the connection 320, the potential 335 is zero (i.e. the potential 335 is removed).

In some instances, the short 305 is applied to the contact surfaces 310 and 315 by the connection 320 only once. In other instances, the short 305 is applied to the contact surfaces 310 and 315 by the connection 320 more than once (e.g., 2, 3, 4, or more than 4 times).

In one instance, the increased amount of atomic surface area 330 in the second surface area state 325 relative to the first surface area state 135 is due to ions being deposited onto the contact surfaces 115 and 120 in the first surface area state 135, thereby changing the contact surfaces 310 and 315 to have the second surface area state 325. In the second surface area state 325, the atomic surface area 330 includes also atomic voids, dents, concave portions, convex portions, protrusions, bubbling effects, or other increased roughness due to the presence of atomic ions, relative to the first atomic surface area 140.

As a result of the increased atomic surface area 330 on the contact surfaces 310 and 315, the power output 340 capacity of the energy source 345 increases relative to the initial power output 150 capacity of the energy source 100. For example, the difference in the power output capacity between the first power output 150 capacity of the energy source 100 and the second power output 340 of the energy source 345 exceeds 1×. In some cases, the difference is about 5×. In some cases, the difference is about 10×, about 15×, about 16×, about 20×, about 25×, or more than about 25×.

In some cases, both process 200 and process 300 can be applied to the same energy source. For instance, process 200 may first be applied to an energy source, followed by process 300 to that same energy source. In a different scenario, process 300 may first be applied to the energy source, followed by process 200 to that same energy source.

In some cases, the electrodes of an energy source are initially shorted for a first period of time, then the short is removed. A current is then applied to those electrodes for a second period of time, then the current is removed. Subsequently, the short may again be applied to the electrodes for a third period of time. The time periods may be the same or they may be different. In some cases, the first and third time periods are the same while the second time period is different. In some cases, the shorting wire has the same wire gauge during both shorting events. In other cases, different gauged wires are used for the different shorting events.

In an alternative scenario, a current may first be applied to the electrodes for a first period of time, then the current is removed. A short may then be applied to the electrodes for a second period of time, then the short is removed. Subsequently, the current may again be applied to the electrodes for a third period of time. In some cases, all three time periods are the same while in other cases all three time periods are different. In some cases, the first and third time periods are the same while the second time period is different. In some implementations, the current level applied during the first process is the same as the current level applied later on. In some implementations, the current levels are different.

In some cases, during a current application event, a progressive increase in current is applied until a threshold level is reached. As an example, initially, 0 mA of current is applied, and then the amount of current is progressively increased until a threshold level is reached within a determined time period. In another scenario, a non-zero amount of current is applied to the electrodes and then that non-zero amount of current is used throughout an entirety of a determined time period. In some cases, a discrete, stepwise increase in current is applied as opposed to a progressive, continual increase in current.

In some cases, the time period in which the short and/or current (collectively the “process”) is applied is anywhere from a select number of seconds to a select number of minutes. For instance, the duration of the process may be 1 second long, 2 seconds, 3 seconds, 4 seconds, 5 seconds, 10 seconds, 20 seconds, 30 seconds, 1 minute, 2 minutes, 3 minutes, 4 minutes, 5 minutes, 10 minutes, or more than 10 minutes. Of course, any time period therebetween (e.g., between 1 second and 10 minutes) can also be used.

### EXPERIMENTAL RESULTS

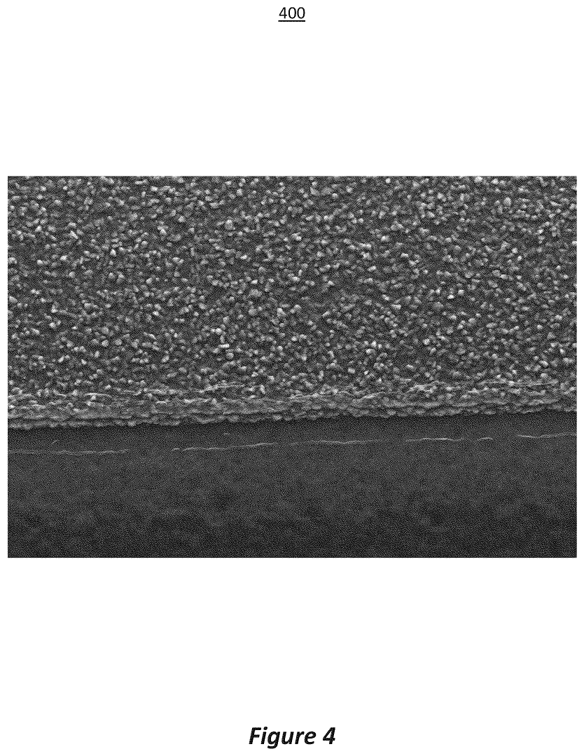

FIG. 4 illustrates an example scanning electron microscopy (SEM) image 400 of a contact surface (e.g., any of contact surfaces 210, 215, 310, or 315) after applying a process (e.g., process 200 or process 300) to change the contact surfaces 115, 120, 125, and/or 130 from FIG. 1A to those of contact surfaces 210, 215, 310, or 315. In other words, the embodiments change the first surface area state 135 to a second surface state (e.g., second surface area state 230 or second surface area state 325) by applying the disclosed processes.

As shown in FIG. 4, the second atomic surface area 235 or 330 includes atomic voids, dents, concavities, convexities, or generally “roughness” as compared to the initial atomic surface area 140, which one can think of as being generally “smooth.” In one instance, the increase in atomic surface area is due to ions being deposited onto the contact surfaces (e.g., contact surface 115, contact surface 120, contact surface 125, or contact surface 130).

The increased surface area shown in FIG. 4 allows an increase in power output (e.g., power output 240 or power output 340) capacity of the energy source (e.g., energy source 220 or energy source 345) relative to the initial power output 150 capacity of energy source 100.

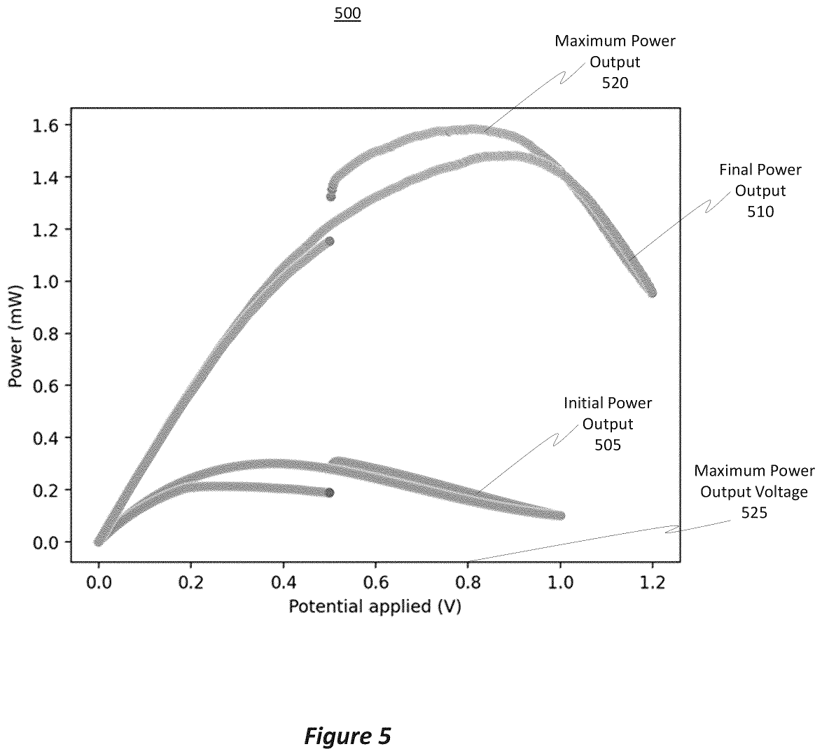

FIG. 5 illustrates a plot 500 showing the experimental results of the final power output 510 (e.g., power output 240 or power output 340) of an energy source (e.g., energy source 220 or energy source 345) after undergoing a process (e.g., process 200 or process 300) relative to an initial power output 505 (e.g., power output 150) of an energy source 100 prior to applying a process (e.g., process 200 or process 300).

As shown in FIG. 5, the process, either process 200 or process 300, results in a final power output 510 (e.g., measured in milli-Watts (mW)) being increased anywhere between about 5×-16× compared to the initial power output 505 measured in mW of the energy source. Additionally (in this example scenario), the maximum power output 520 of the modified energy source, due to the changed atomic surface area of the contact surfaces, occurs at a maximum power output voltage 525. Advantageously, the disclosed embodiments can be implemented when faced with a scenario where receiving units 145 operate only at specific voltages.

As a specific example, the silicon substrate 105 of FIG. 1A includes contact surfaces 115 and 120, and that energy source 100 operates at a 0.8 potential applied voltage (e.g., as shown by maximum power output voltage 525 in FIG. 5) to obtain a maximum power output 520, as shown in FIG. 5. In this instance, the energy source 100 is optimized to produce a maximum power output 520 at a maximum power output voltage 525 relating to the voltage and power output required for receiving unit 145. In other embodiments, the maximum power output 520 occurring at a maximum power output voltage 525 occurs at a different voltage based on the receiving unit 145.

In other words, the embodiments can be configured to enable a maximum power output to be achieved at a specific operating voltage for a receiving unit. As an example, suppose a receiving unit operates at “x” voltage. The disclosed principles can be performed to increase the atomic surface area of the electrodes of the energy source. These processes can be performed in a manner so that the energy source has a power output peak at the “x” voltage level of the receiving unit.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

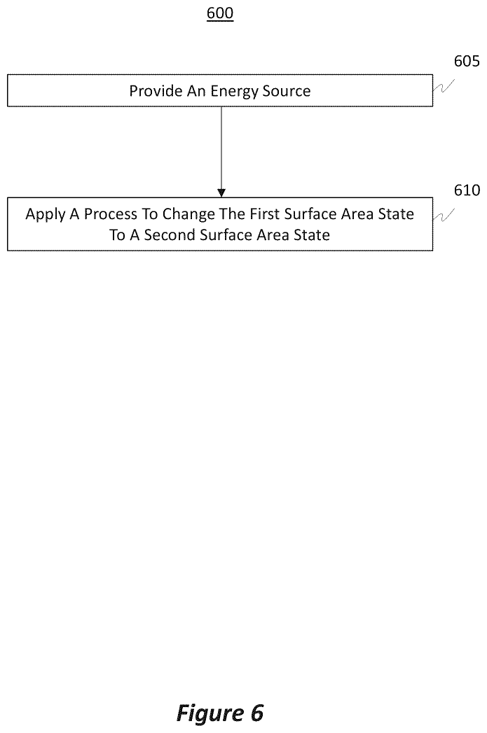

Attention will now be directed to FIG. 6, which illustrates a flowchart of an example method 600 for increasing a power output from an energy source due to modified atomic surface areas of contact surfaces within the energy source.

Method 600 includes an act (act 605) of providing or accessing an energy source. The energy source includes a first contact surface and a second contact surface. The first and second contact surfaces are structured to facilitate a transfer of energy from the energy source to a receiving unit. Notably, the first and second contact surfaces are electrodes/terminals.

The first and second contact surfaces initially have a first surface area state in which the first and second contact surfaces have a first amount of atomic surface area. By way of reference, the first contact surface 115 and the second contact surface 120 have a first surface area state 135 with an atomic surface area 140. Energy source 100 has an initial power output 150. The first contact surface 115 and the second contact surface 120 are connected to a receiving unit 145 to facilitate transfer of energy based on the power output 150 between the first contact surface 115 and the second contact surface 120 and the receiving unit 145. In one example, the energy source is a battery. This battery can be one of: a silver-platinum battery, a flow battery, a lithium-ion battery, a lead-acid battery, or a solid state battery.

Method 600 also includes act 610 of applying a process to change the first surface area state to a second surface area state in which the first and second contact surfaces have a second amount of atomic surface area, which is an increased amount of atomic surface area relative to the first amount of atomic surface area. As an example, the first surface area state 135 can be thought of as having a “smooth” or “smoother” surface area state (e.g., a metallic surface area state) that changes to a second surface area state (e.g., second surface area state 230 or second surface area state 325) which includes a “rough” or “roughened” surface area state relative to the first surface area state 135.

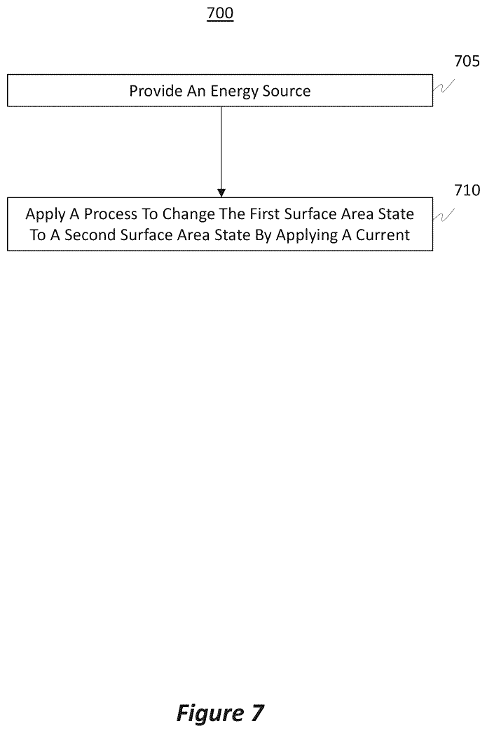

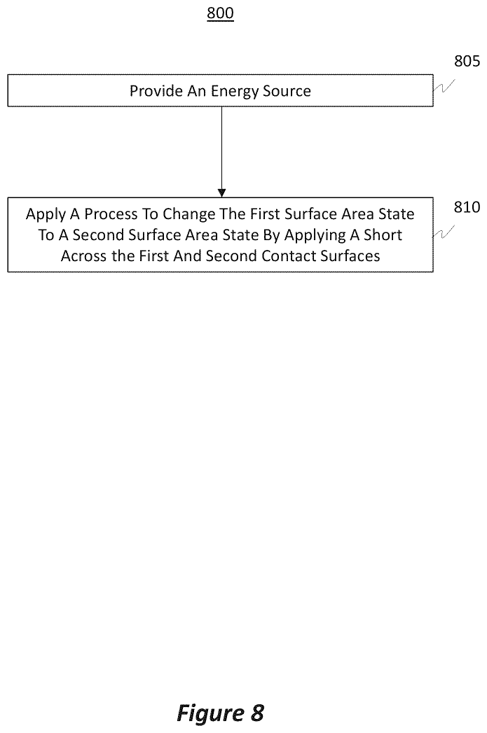

In some instances, the roughened surface area state occurs due to depositing ions on the contact surfaces (e.g., contact surface 115, contact surface 120, contact surface 125, or contact surface 130). The “process” of act 610 can be either a process in which current is applied to the electrodes (as will be described with respect to FIG. 7) or a process in which a short is applied across the electrodes (as will be described with respect to FIG. 8). In some embodiments, applying the process includes depositing ions onto the first and second contact surfaces to create the second surface area state.

FIG. 7 illustrates a flowchart of an example method 700 for increasing a power output from an energy source due to modified atomic surface areas of contact surfaces within the energy source by applying a current to the electrodes of the energy source.

Method 700 includes an act (act 705) of providing an energy source. The energy source includes a first contact surface and a second contact surface. The first and second contact surfaces are structured to facilitate a transfer of energy from the energy source to a receiving unit, and the first and second contact surfaces initially have a first surface area state in which the first and second contact surfaces have a first amount of atomic surface area.

Method 700 also includes act 710 of applying a process to change the first surface area state to a second surface area state by applying a current to the electrodes of the energy source. By applying this current, the atomic surface area characteristics of those electrodes changes. For example, as a result of applying the current, the first and second contact surfaces will now have a second amount of atomic surface area, which is an increased amount of atomic surface area relative to the first amount of atomic surface area.

Stated differently, in some implementations, the process comprises applying a current to the first and second contact surfaces. Such a process results in the first and second contact surfaces being modified to have the second amount of atomic surface area. In some implementations, the applied current is between about 100 mA and about 600 mA.

FIG. 8 illustrates a flowchart of an example method 800 for increasing a power output from an energy source due to modified atomic surface areas of contact surfaces within the energy source by applying a short across the electrodes of the energy sources.

Method 800 includes an act (act 805) of providing an energy source configured in the manner described above. Optionally, the energy source may include a third or perhaps a fourth contact surface. In some cases, the energy source may have more than four contact surfaces.

Method 800 also includes act 810 of applying a process to change the first surface area state to a second surface area state by applying a short across the energy source's electrodes. If two electrodes are present, then those two electrodes are connected or shorted together. If three electrodes are present, then those three electrodes are connected or shorted together. If four electrodes are present, then it may be the case that two of the electrodes are anodes and two are cathodes. In a first example scenario, one anode may be connected to one cathode, and the other anode is connected to the other cathode. The two shorts, in some cases, may not be connected to one another. In some other cases, the two shorts may be connected to one another, resulting in both anodes being shorted to both cathodes simultaneously.

As another example, a short is applied from a negative electrode of the energy source to the positive electrode of the energy source. Doing so modifies the atomic surface area characteristics of those electrodes, resulting in the first and second contact surfaces (i.e. electrodes) now having a second amount of atomic surface area, which is an increased amount of atomic surface area relative to the first amount of atomic surface area.

Stated differently, in some implementations, applying the process includes shorting the first and second contact surfaces together. Such a process results in the first and second contact surfaces being modified to have the second amount of atomic surface area. Regardless of what process is used, applying the process enables the energy source to provide an increased power output relative to a power output the energy source provided prior to the process being applied. In some implementations, the increased power output of the energy source occurs at a specific voltage.

### Specific Example

A specific example will now be provided. A skilled person will understand how, although this specific example recites particular values, dimensions, and scenarios, the disclosed principles can be implemented in a broader manner. Thus, the following example is provided for illustrative purposes only and should not be viewed as being limiting or binding to the scope of the disclosed principles.

Consider a scenario where a silicon wafer has the following dimensions: 525 microns thick and 4 inches in diameter. Several different channels can be etched into the silicon wafer. These channels can, for example, be about 5 microns deep. These channels can be formed by masking processes, photoresist processes, or dry chemical reactive etching processes (e.g., in a clean room).

The positive and negative electrodes can be deposited on a glass wafer, such as by using gold or platinum. This deposition process can be performed via sputtering. Metal deposition by sputtering typically starts by creating a high electrical field around a source material of interest. The electrical field creates plasma and removes material atoms from the source material. The removed material is then deposited on a substrate of interest.

The silicon wafer is etched with channels that are bonded to a secondary glass wafer on which the electrodes are deposited. Doing so avoids leakage during electrolyte flow. An anodic bonding technique can be used. This technique provides a solid chemical bond between the silicon and the glass. With this technique, the bonding temperature is often between about 400 degrees Celsius and about 450 degrees Celsius. A voltage between about 400 volts and about 1200 volts is also applied. Under this high voltage, mobilized sodium ions in the glass wafer migrate in the direction of the cathode.

After mounting an integrated circuit (IC) chip on top of the silicon wafer, through-silicon vias (TSVs) through the silicon substrate are used to make electrical connections between the IC chip and the electrodes. These TSVs are manufactured through a multistep process that includes masking, copper metal evaporation, electroplating, grinding and polishing. For a prototype, a simpler process of via-filling can be performed by creating a through hole by chemical etching and reflowing molten metal wire (indium) through the silicon using soldering process.

Vanadium in two charged states V⁵⁺ and V²⁺ flows on either side of the same microfluidic channel in laminar flow at flow rates of 3-5 ml/min. A pressure pump is used to flow the electrolyte in and out of the microfluidic channel. A chip holder is fabricated to hold the chip in place and to have manifolds for electrolytic flow in and out of the flow cell. A potentiostat records voltage, current, and power delivery by the flow cell integrated inside the silicon.

One can ensure that all the parts, such as pumps, sensors, and flow meters are Vanadium and Sulfuric acid compatible. One can also ensure that the outlet discharge is gradually reduced to ambient by increasing the pipe lengths. Air bubble detection in the flow meters and inside the flow cell is provided to ensure there are no air bubbles in the flow channels. One can also ensure that the flow is precisely programmable and independently controllable. One also ensures the same flow rate (1-5 ml/min laminar flow) is maintained on both the cathode and anode compartments in the flow channel.

Voltage is then imposed (e.g., varying between 0 V and 1.5V). The current and power generated is measured by flowing the vanadium electrolyte. The two ends of the electrode can also be shorted by connecting them with a copper wire. The electrical short is then removed, and the power draw and current is measured again. The process of shorting and removing the short may be repeated several times, and plots of the power output at various voltages can be generated. As an alternative, current can be applied to the electrodes.

In an experiment, prior to the shorting event, the power output from the circuit was observed to be 0.1 mW at a voltage of 0.8 Volts. After the shorting event, the electrical power output increased up to 1.6 mW at 0.8 Volts, a factor of almost 16×. Scanning electron microscopy images show that the increase in power delivery is due to an increase in electrode surface area, which occurred during the shorting event. Improved surface area at atomic scales results in improved efficiency of the die-integrated flow battery, or any type of battery.

Accordingly, some embodiments are directed to an energy source that is structured to increase an atomic surface area of contact surfaces of the energy source to thereby cause the energy source to increase an amount of energy output the energy source is capable of providing relative to an amount of energy output the energy source was capable of providing prior to the atomic surface area being increased. The energy source includes a first contact surface and a second contact surface.

The first and second contact surfaces are structured to facilitate a transfer of energy from the energy source to a receiving unit. The first and second contact surfaces initially have a first surface area state in which the first and second contact surfaces have a first amount of atomic surface area.

In some embodiments, a current is applied to the first and second contact surfaces to change the first surface area state to the second surface area state in which the first and second contact surfaces have a second amount of atomic surface area, which is an increased amount of atomic surface area relative to the first amount of atomic surface area. Optionally, the applied current can be between about 120 mA and about 500 mA. Of course, other amperage levels can be used as well. The current may be applied for a predetermined time period (e.g., at least 10 seconds, in some embodiments).

In some embodiments, a short is applied to the first and second contact surfaces to change the first surface area state to the second surface area state in which the first and second contact surfaces have a second amount of atomic surface area, which is an increased amount of atomic surface area relative to the first amount of atomic surface area. The short may be applied for a predetermined time period.

### ADDITIONAL TERMS

The present disclosure may be embodied in other specific forms without departing from its essential characteristics. The described embodiments are to be considered in all respects only as illustrative and not restrictive. All changes which come within the meaning and range of equivalency of the claims are to be embraced within their scope.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed is:

1. A method for increasing an atomic surface area of contact surfaces of an energy source to thereby cause the energy source to increase an amount of energy output the energy source is capable of providing relative to an amount of energy output the energy source was capable of providing prior to the atomic surface area being increased, said method comprising:
providing an energy source, wherein the energy source includes a first contact surface and a second contact surface, the first and second contact surfaces being structured to facilitate a transfer of energy from the energy source to a receiving unit, and wherein the first and second contact surfaces initially have a first surface area state in which the first and second contact surfaces have a first amount of atomic surface area; and
applying a process to change the first surface area state to a second surface area state in which the first and second contact surfaces have a second amount of atomic surface area, which is an increased amount of atomic surface area relative to the first amount of atomic surface area.

2. The method of claim 1, wherein applying the process comprises applying a current to the first and second contact surfaces, resulting in the first and second contact surfaces being modified to have the second amount of atomic surface area.

3. The method of claim 2, wherein the applied current is between about 100 milliamp (mA) and about 600 mA.

4. The method of claim 1, wherein applying the process comprises shorting the first and second contact surfaces together, resulting in the first and second contact surfaces being modified to have the second amount of atomic surface area.

5. The method of claim 1, wherein the energy source includes a third contact surface.

6. The method of claim 1, wherein applying the process to the energy source results in the first and second contact surfaces having the second amount of atomic surface area, which enables the energy source to provide an increased power output relative to a power output the energy source provided prior to the process being applied.

7. The method of claim 6, wherein the increased power output of the energy source occurs at a specific voltage.

8. The method of claim 1, wherein the energy source is a battery.

9. The method of claim 8, wherein the battery is one of: a silver-platinum battery, a flow battery, a lithium-ion battery, a lead-acid battery, or a solid state battery.

10. The method of claim 1, wherein the first and second contact surfaces are electrodes.

11. The method of claim 1, wherein applying the process includes depositing ions onto the first and second contact surfaces to create the second surface area state.

12. An energy source that is structured to increase an atomic surface area of contact surfaces of the energy source to thereby cause the energy source to increase an amount of energy output the energy source is capable of providing relative to an amount of energy output the energy source was capable of providing prior to the atomic surface area being increased, the energy source comprising:
a first contact surface; and
a second contact surface;
wherein:
the first and second contact surfaces are structured to facilitate a transfer of energy from the energy source to a receiving unit,
the first and second contact surfaces initially have a first surface area state in which the first and second contact surfaces have a first amount of atomic surface area, and
a current is applied to the first and second contact surfaces to change the first surface area state to the second surface area state in which the first and second contact surfaces have a second amount of atomic surface area, which is an increased amount of atomic surface area relative to the first amount of atomic surface area.

13. The energy source of claim 12, wherein the current is applied for at least 10 seconds.

14. The energy source of claim 12, wherein the applied current is between about 120 milliamp (mA) and about 500 mA.

15. The energy source of claim 12, wherein the energy source is a battery, and wherein the first and second contact surfaces are electrodes.

16. The energy source of claim 12, wherein the current is applied for a predetermined time period.

17. An energy source that is structured to increase an atomic surface area of contact surfaces of the energy source to thereby cause the energy source to increase an amount of energy output the energy source is capable of providing relative to an amount of energy output the energy source was capable of providing prior to the atomic surface area being increased, the energy source comprising:
a first contact surface; and
a second contact surface;
wherein:
the first and second contact surfaces are structured to facilitate a transfer of energy from the energy source to a receiving unit,
the first and second contact surfaces initially have a first surface area state in which the first and second contact surfaces have a first amount of atomic surface area, and
a short is applied to the first and second contact surfaces to change the first surface area state to the second surface area state in which the first and second contact surfaces have a second amount of atomic surface area, which is an increased amount of atomic surface area relative to the first amount of atomic surface area.

18. The energy source of claim 17, wherein, after the short is applied, a current is applied to the first and second contact surfaces.

19. The energy source of claim 17, wherein the energy source is a battery, and wherein the first and second contact surfaces are electrodes.

20. The energy source of claim 17, wherein the short is applied for a predetermined time period.
